(19) United States
(12) Patent Application Publication
(10) Pub. No.: US 2017/0024523 A1
(43) Pub. Date: Jan. 26, 2017

(54) Requirement Forecast for Health Care Services

(71) Applicant: Uptake Technologies, Inc., Chicago, IL (US)

(72) Inventors: Alexander Gutfraind, Chicago, IL (US); Adam McElhinney, Chicago, IL (US); James Herzog, Downers Grove, IL (US)

(21) Appl. No.: 14/807,213

(22) Filed: Jul. 23, 2015

(51) Int. Cl. G06F 19/00; G06N 5/04

(52) U.S. Cl. CPC G06F 19/327; G06N 5/04

(57) ABSTRACT

Implementations generally relate to forecasting a support requirement for a health care unit to use in preparing patient support at a target time. In some implementations, a method includes accessing external conditions data for a plurality of different external conditions projected for the location at the target time. The target time and the external conditions data may be provided into a prediction model, which identifies one or more reference times prior to the target time that are predictive of the target time, accesses historical data for the reference times, and outputs the data indicating a support requirement based on the historical data and external conditions data.

### BACKGROUND

Health care providers serve various patient populations that have fluctuating needs over time. They need to ensure that adequate support, such as staff, equipment, medications, supplies, space, etc., are available to accommodate changes in patient population requirements. Health care providers may face increases or dips in demand resulting from various events or occurrences. They may want to adjust their resources to address such variations in demand.

### OVERVIEW

Implementations generally relate to projecting a support requirement for a health care unit at a particular target time in the future. The method may be implemented by a computing device of a health care management system. In some implementations, a method includes receiving a request to project a staffing requirement at a health care unit during a target time. External conditions data for a plurality of different external conditions projected for the location at the target time may be accessed. The method may further include providing the target time and the external conditions data into a prediction model. The prediction model may identify one or more reference times prior to the target time that are predictive of the target time. The prediction model may also access historical data for a staffing requirement for each of the one or more reference times. The prediction model may further output data indicating a staffing requirement for the target time based, at least in part, on the historical data and the external conditions data for the target time. Data that indicates a staffing requirement may be provided to another computing device for use in scheduling one or more staff members to meet the staffing requirement for the health care unit.

In some implementations, a method that may be implemented by a computing device, may include receiving a request to project a support requirement at a health care unit at a target time. External conditions data for a plurality of different external conditions projected for the location at the target time may be accessed. The method may further include providing the target time and the external conditions data into a prediction model. The prediction model may identify one or more reference times prior to the target time that are predictive of the target time. The prediction model also access historical data for a support requirement for each of the one or more reference times. Further, the prediction model output data indicating a support requirement for the target time based, at least in part, on the historical data and the external conditions data for the target time. The data indicating a support requirement may be provided to another computing device for use in preparing patient support at the health care unit to meet the data indicating a support requirement.

In some aspects, the method may include providing support requirement to a staff scheduler for the health care unit. In addition, the method may include providing a command to the staff scheduler to automatically schedule one or more staff members for the target time at the health care unit based, at least in part, on the data indicating a support requirement. Some implementations may also include providing a second command to the staff scheduler to automatically provide an alert to the one or more of the staff members scheduled for the target time.

In some aspects, the method may include determining an identifier for a staff member that meets a suitability criterion that is based, at least in part, on an individual attribute. The identifier for the individual staff and data indicating a support requirement may be used in providing a command to the staff scheduler to automatically schedule one or more staff members for the target time at the health care unit based, at least in part, on the data indicating a support requirement and the identifier.

With further regard to the method, in some implementations, the historical data may include health characteristics that may need support during the first reference time. In some implementations, the external conditions data include data for at least one of weather, pollen count, traffic, air quality, crime activity and disease trend. Also, in some implementations, the data output is further based, at least in part, on one or more weights associated with the external conditions data. At times, the request to provide the support requirement may be received from another computing device.

In some implementations, the method may include accessing time characteristics for the location at the target time. The one or more reference times may also be identified by accessing external conditions data and time characteristics for potential reference times and comparing the potential reference time external conditions data and time characteristics to the external conditions data and time characteristics for the location at the target time.

The method, in some implementations, may include accessing external conditions data for the one or more reference times and comparing external conditions data at the one or more reference times to the external conditions projected for the location at the target time. The historical data may be adjusted for each of the one or more reference times based, at least in part, on the comparison of external conditions data. Further, the output of the data indicating a support requirement for the target time may be based, at least in part, on the adjusted historical data for each of the one or more reference times.

In some implementations, the method may include identifying one or more reference times by accessing an index of normalized historical data reflecting a normalized staffing requirement for each of the one or more reference times based, at least in part, on external conditions at the one or more reference times. The output of the data indicating a support requirement for the target time may be further based, at least in part, on the normalized historical data reflecting a staffing requirement for each of the one or more reference times.

The method may involve iterations of updated projections at times. In these cases, the method may include performing subsequent iterations of accessing additional external conditions data associated with the plurality of different external conditions for additional second reference times. The method further may include outputting updated data indicating a support requirement for the target time based, at least in part, on the historical data and the external conditions data for the target time. Each additional second reference time may be progressively closer to the target time and not the same as the target time for each subsequent iteration. The method may further include providing the updated data indicating the support requirement to another computing device for use in preparing patient support at the health care unit to meet the updated data indicating a support requirement.

In yet some implementations, an health care management system is provided in which a memory may be coupled to one or more processors and configured to store instructions that cause the processor to perform operations. Such operations may include receiving a request to project a support requirement at a health care unit in a location at a target time and accessing external conditions data for a plurality of different external conditions projected for the location at the target time. Operations may additionally provide the target time and the external conditions data into a prediction model, in which the prediction model may identify one or more reference times prior to the target time that are predictive of the target time, historical data for each of the identified reference times, and output data indicating a support requirement for the target time based, at least in part, on the historical data and the external conditions data for the target time. The data indicating a support requirement may be provided to another computing device for use in preparing patient support at the health care unit to meet the data indicating a support requirement.

In some implementations, the support requirement may be provided to a computing device that is a staff scheduler for the health care unit and a command may be provided to the staff scheduler to automatically schedule one or more staff members for the target time at the health care unit based, at least in part, on the support requirement. In still some implementations, operations may include providing a second command to the staff scheduler to automatically provide an alert to the one or more staff members scheduled for the target time. At times, the historical data may include one or more health characteristics indicating a support requirement

In some aspects of the system, the instructions may further cause the one or more processors to determine an identifier for the one or more staff members that meet a suitability criterion that may be based, at least in part, on an individual attribute. The command to the staff scheduler to automatically schedule the one or more staff members may be further based, at least in part, on the identifier for the one or more staff members.

Further instructions may cause the one or more processors to determine data indicating a support requirement for the one or more reference times, compare external conditions data at the one or more reference times to the external conditions projected for the location at the target time, and adjust the data indicating a support requirement for each of the one or more reference times based, at least in part, on the comparison of external conditions data. In some implementations the data indicating a support requirement for the target time may be outputted based, at least in part, on the adjusted data indicating a support requirement at the one or more reference times.

Further instructions may cause the one or more processors to determine data indicating a support requirement for the one or more reference times, and normalize the data indicating a support requirement based, at least in part, on external conditions at the one or more reference times. The data indicating a support requirement for the target time may be output based, at least in part, on the normalized data indicating a support requirement at the one or more reference times.

### BRIEF DESCRIPTION OF THE DRAWINGS

FIG. 1 is a conceptual diagram illustrating an example environment in which various aspects of forecasting a support requirement of a health care unit can be implemented in a health care management system.

FIG. 2 is a flow diagram of an example projection process for determining a support requirement.

FIG. 3 is a flow diagram of an example projection process for determining a support requirement.

FIG. 4 is a flow diagram of an example projection process for determining a support requirement.

FIG. 5 is a flow diagram of an example projection process for determining a support requirement.

FIG. 6 is a flow diagram of an example process of updating projection of a support requirement.

FIG. 7 is a schematic diagram illustrating selected example components of a computing device of a health care management system that implements the process of projecting of a support requirement of a health care unit.

FIG. 8 is a schematic diagram illustrating selected example components of a computing device of a health care unit that implements planning for the provision of health care based on a projection of a support requirement; all in accordance with the present disclosure.

### DETAILED DESCRIPTION

The following disclosure makes reference to the accompanying figures and several exemplary scenarios. One of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

In various implementations, a health care management system provides a tool for projecting a support requirement of a health care unit to support demands for health care at a given time in the future. A variety of health care units may benefit from the present health care management system, including departments, offices, clinics, hospitals, agencies, coordinators, facilities, day care centers, etc. The health care units may provide various health care services, such as emergency room care, urgent care, intensive care, critical care, internal medicine, pediatrics, gynecology, obstetrics, behavioral health, social work, case management services, elderly care, assisted living, long term care, home care, residential care, physiotherapy, ophthalmology, dentistry, pharmacy, radiology, veterinary services, chiropractic and alternative medicine, life assistance services, etc.

The kind of support that a health care unit may need to provide at any given time is as diverse as the type of health care units. In practice, the present health care management system may provide projections of various levels of a support requirement depending on desired granularity of the projections of support requirements. Presented herein are examples of a variety of support requirements that may be provided by the health care management system to assist a health care unit in supporting forecasted patient needs.

In some instances, a support requirement may be in the form of a basic results data, such as a projected number of patients entering an emergency room or the amount of a supply of a particular medicine that may need to be dispensed. Other examples of basic data are also possible.

A support requirement in the form of basic data may also include health condition characteristics projected at a particular time. Such basic data may be used to identify staff having specialty skills or experience, particular equipment, types of medication, and certain supplies projected to be needed for patients based on the health condition characteristics of future patients during the target time. For example, a health condition characteristic may be, for example, a kind, feature or description of a particular type of health care, e.g. surgery. In some implementations, a health condition characteristic may include a rating of levels of criticality, such as one to five with one being most severe and five being the least severe, e.g. a minor injury requiring medical attention sometime within the next 72 hours may have a lower level of criticality, whereas a major trauma requiring immediate attention within the next 30 minutes may have a higher level of criticality. Other health condition characteristics may include types of patient needs, presentation of clinical symptoms, diagnoses, outcomes, equipment required to care for the patients, medications needed, supplies required, etc.

In some implementations, the support requirement may be specific support needs interpreted from the basic data. The health care management system may insert the basic data into various formulas that convert number of patients to specific support needs, such as a number of nurses, doctors and administrative staff needed at a target time in the future. In these cases, the specific support requirement provided by the health care management system to a health care unit may include projected staffing requirements. For example, a variety of nurse to patient formulas may be applied to determine nurses needed to fill a support requirement during a target time, such as a formula that considers productive work hours of nurses per patient day. In some implementations, the health care management system may insert basic data into various formulas that may calculate number or kind of rooms, number of beds and/or amount of space needed at the target time. Support requirements may be presented to a health care unit by the health care management system in the form of data indicating the support requirement.

At times, the services required by a health care unit may fluctuate due to irregular changes in the needs of patients. For example, periodically more patients may be in need of certain care and at other occasions fewer patients may need the same type of care. The term “patients” as used herein includes current patients and past patients, as well as potential future patients, and combinations thereof. Some variations in needs may be due to the state of certain factors (e.g. state of the weather, traffic, crime) or events (e.g. a specific storm, a specific traffic accident) that occur outside of the health care unit. One or more such states or events may be presented in the form of external conditions data that represents external conditions. The health care management system may provide projections of needs by considering prior needs of patients at the health care unit and external conditions that can affect patient demands.

Some implementations are applicable to a health care unit that may make plans according to projected fluctuations. A health care unit may benefit from a management system that takes into consideration the potential impact of known factors. For example, a given hospital serving as a health care unit may benefit from incorporating external conditions, such as weather and police efforts to generate staff schedules as well as time characteristics, such as a holiday. For example, the given hospital may find that in prior years, on the 4^{th} of July, it experienced an increase in patients entering its emergency room. These patient counts may be considered historical data. However, on a particular upcoming 4^{th} of July, the local police department plans to double its patrols and check points. Suppose for this example, that there is evidence that suggests the extra police efforts are correlated with a decrease in traumatic injuries and patients entering an emergency room.

In addition, in this example scenario, an extreme heat wave is forecast for July 4^{th}. Further suppose, that there is evidence that a day temperature over 100 degrees Fahrenheit is associated with a reported rise in health related problems, such as heat stroke and dehydration. The heat wave may impact the health care needs of emergency rooms. The police efforts and weather in this case are examples of external conditions that may be taken into account to determine a support requirement. Values that correspond to the temperature and amount of police enforcement may be factored as external conditions data by the health care management system.

In the foregoing example, a staff scheduler may gain value from a projection of how many individuals it needs to schedule for on call and regular shifts to support the emergency room on an upcoming July 4^{th}. Accordingly, advantages are provided by a health care management system that provides an indication of fluctuations in patient demand to the hospital's staff scheduler based, in part, on the external conditions.

At times, health care units may experience a dramatic change in demand, as represented by a spike or drop in patient volume. Challenges may arise for health care units when a patient surge leading to a strain on the unit's resources. Unforeseen demand spikes may result in excessive patient waiting time, unavailability of staff, capacity constraints, lack of supplies or medications, increased wait times for equipment etc. Even a gradual change in needs may impact resources of a health care unit. For example, a long term decrease in the use of particular medications and supplies may lead to excess inventory and waste due to expiry of medicines. The many interwoven factors that can influence demands for health care may make predictions of future needs problematic.

A health care management system may create projections of health care needs by integrating findings from various sources. The health care management system may consider patterns in data across wide and diverse arrays of external conditions. The system may engage in deep and rich data collection and pull complex data into useable solutions. In addition, the health care management system may connect with a health care unit to deliver insights, e.g. projections for support requirements, as needed to optimize planning capabilities that may exceed what a health care unit may achieve on its own without the benefit of the health care management system.

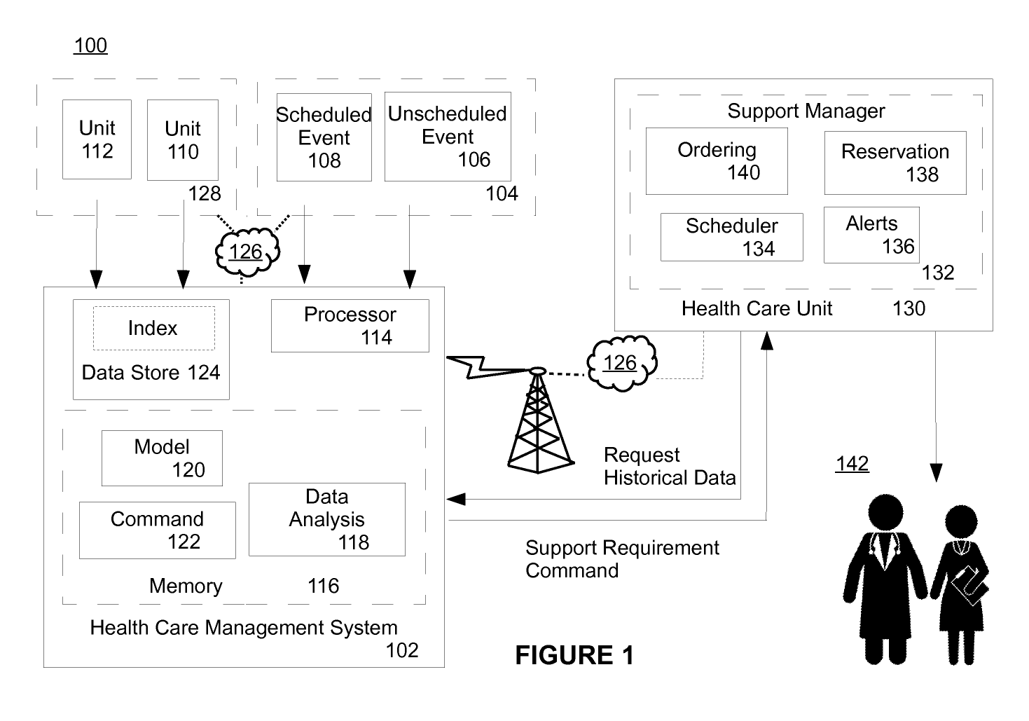

FIG. 1 illustrates an example network environment 100 in which various aspects of forecasting a support requirement of a health care unit 130 can be implemented in a health care management system 102. The health care management system 102 may gather data, such as across one or more networks 126. The health care management system 102 may interpret the data to determine information regarding care that may be required of a health care unit 130 at a future time in the form of a support requirement. The health care management system 102 and a computing device for the health care unit 130 may communicate by exchanging information, requests, commands, etc. with each other across a network 126 to implement management of future support requirements. Communications across the one or more networks 126 may include privacy and security measures, such as encryption and password protection.

Referring to FIG. 1, the health care management system 102 may acquire external conditions data from one or more various external conditions data sources 104, such as generators or accumulators of data, configured to communicate with the health care management system 102, such as across a network 126 described in more detail below. Examples of external conditions data sources 104 may include weather-data servers, traffic monitoring servers, emergency notification systems, etc. The external conditions data reflect specific information at a given time for a plurality of different external conditions. External conditions data may be represented in one or more formats, including numeric, Boolean, categorized, etc. The external conditions may impact a support requirement at a health care unit 130 and may be relevant to the functions performed by the health care unit 130.

In some implementations, an external conditions data source 104 may be or include one or more computing systems configured to collect, store, and/or provide external conditions data to other systems, such as the health care management system 102. The external conditions data sources 104 may be configured to generate and/or obtain external conditions data independently from the health care unit 130. In some examples, the health care management system 102 may receive external conditions data hosted by an external conditions data source 104 by subscribing to a service provided by the data source 104.

In various examples, the health care management system 102 may receive data from an external conditions data source 104 in other ways. For example, the external conditions data source 104 may support ad-hoc requests for data, such as via a webpage in which a user may enter a query for external conditions data. In some implementations, the external conditions data source may respond to scheduled queries from the health care management system 102 that may be stored in a schedule database with prearranged times to provide external conditions data. In still some implementations, the external conditions data source may trigger sending data, such as a notification pushed to the computing system 102, based on changes in parameters (e.g. storm conditions observed, traffic accident observed, etc.).

In various example implementations, external conditions are factors that are removed from the health care unit 130, such that the external conditions are independent from the health care unit. One or more external conditions may, in some examples, have the potential to impact the support that may be required of a health care unit 130. Previous experience, studies, or other assumptions may provide evidence of the influence the external conditions may have on a health care needs of a population.

Some external conditions may include factors that are not regularly prearranged, such as environmental factors, for example, weather, pollution levels and pollen counts. Other external condition examples may include crime, employment, food security such as nutrition and food safety, disease trends, availability of public transportation, other stress inducing conditions, etc.

Some external conditions may include events that occur at a given location and time. For example, events that make up external conditions may include a storm, traffic accident, natural disaster, exposure to toxic substances, parade or other celebration, events posted to a calendar, etc. Further external conditions are possible.

External conditions may include sub-parameters that provide a higher granularity for characteristics of conditions that may impact health care needs. For example, weather conditions may include sub-parameters of temperature, storm, flooding, humidity, precipitation, fog, sunshine, wind, atmospheric pressure, etc. Traffic conditions may include sub-parameters, for example, including an accident, flow, a blockage, an inadvertent condition of a roadway, such as moisture on a road, etc.

In some implementations, external conditions data may be associated with an external condition that is related to demographic information of a population that may be affected by a condition within the regional location of the health unit, such as age, gender, behavior, economic status, prior medical conditions, etc.

In some circumstances, external conditions data may be related to other external conditions data. For example, a road closure may lead to increased traffic. In these cases, the health care management system 102 may select one or more of the overlapping external conditions to use in determination of a support requirement. The use of external conditions in this manner may improve the reliability of predictions of a support requirement of a health care unit at a specific time.

The foregoing are some non-limiting examples of external conditions and numerous others are possible. Other categories of external conditions may reflect gradual trends that affect the health of a population over a period of time. For example, some policies, such as tobacco use regulations and auto safety rules, may correlate with long-term effects on the needs of a health care unit.

Patterns in external conditions data associated with external conditions may be identified by a series of data and may be used to define effective external conditions data sets. For example, a weather pattern may show repeating temperature changes over the course of a year and such a pattern may enable interpretation of future temperatures and external conditions data sets.

External conditions may have time and regional characteristics. The health care management system 102 may select external conditions and external conditions data sources 104 that provide external conditions data that can offer a threshold level of predictability of health care needs of a health care unit at a target time and/or the location of a health care unit.

In some implementations, the selection of external conditions may be dynamic. In some implementations, the dynamic selection may be for a health care management system that learns from prior projections. In some implementations where the health care management system learns from prior projections, additional connections may be made between a projected support requirement at the health care unit 130 and previous actual support requirements at the health care unit at a given time. The determined connections can indicate a change of external conditions that serve as leading indicators, e.g. finding that certain external conditions data correlates better with a desired support requirement. In some cases, the determined connections may suggest a need to change a prediction model used to project a support requirement as described further below.

In some implementations, the health care management system 102 may operate efficiently by limiting external conditions data acquisition to the necessary external conditions data, which, for example, correlate well with the health care services provided by the health care unit 130. Such external conditions data may have a marked effect on a support requirement of the health care unit 130 for the target time. External conditions data that do not impact or have minimum influence on a support requirement may be considered unnecessary external conditions data and may burden the health care management system 102. When external conditions data is deemed unnecessary, the health care management system 102 may reject the external conditions data, delete such unnecessary external conditions data, cease to request the unnecessary external conditions data from its associated external conditions data source, utilize other methods to rid itself of unnecessary external conditions data, or combinations thereof.

In some implementations, one or more historical data sources 128, such as sources that host historical data may be associated with other health care units 110 and 112. Such historical data may be basic data related to previous allocation of resources experienced by the other health care units 110 and 112 and/or the requesting health care unit 130 during a particular reference time. For example, historical data may include the number of patients entering an emergency room, the amount of a supply of a particular medicine that was dispensed, or the number of beds previously used. Other examples of basic data are also possible.

In various implementations, the other health care units 110 and 112 may be distinct from the health care unit 130. The historical data sources may be one or more of the health care units 110, 112 and 130. Any number of health care units may be employed. In some implementations, the historical data source may be one or more storage units, such as a remote server housed at a remote source that hosts such historical data for the health care units 110, 112 and 130.

In some implementations, historical data for the other health care units 110 and 112 may be used if they meet a threshold of correlation with the health care unit 130 that requests a support requirement. Thresholds of correlation may include various factors such as proximity to the requesting health care unit and similarity of type of health care provided, size, capacity, health care specialty, types of physicians, available diagnostic and procedural equipment, etc. Other thresholds based on other factors may be possible.

In some implementations, historical data may comprise personal health data, such as data collected from electronic devices of patients. The electronic devices may gather personal health data from the patient, such as with the use of sensors, and transmit the personal health data. Sources of personal health data may include, for example, pacemakers, insulin measurements, heart rate monitors, pedometers, activity monitors, digestive monitors, wearable monitors, head mounted display monitors, activity monitors integrated with mobile devices, etc. Some wearable devices may continuously collect physiological signals such as heart rate, respiration rate, oxymetry, blood pressure and other signals indicative of health for use as personal health data. The health care management system 102 may also receive historical data for the requesting health care unit 130 for a particular reference time. The reference time may be specifically selected as a time that may significantly correlate with the projected needs of the health care unit 130 at the target time.

In some implementations, a reference time and/or target time may have one or more related time characteristics. Time characteristics may include, for example, holidays, time of day, seasons, etc. In some implementations, time characteristics may be obtained from a calendar service that automatically, without user input, tracks and maintains birthdays, anniversaries, etc.

In various implementations, historical data for the health care unit 130 may be provided from the health care unit 130. In still some implementations, the historical data for the health care unit 130 may be provided by one or more other sources.

In some examples, the health care unit 130 may provide historical data that represents the resources required of the health care unit 130 at some earlier reference time, such as one year before the target time. The historical data may reflect allocation of resources that were required at the reference time, such as prior staffing requirements for the health care unit 130, for example, the number and/or type of staff that was previously provided by the health care unit 130 at a reference time, the number and/or type of staff that was previously required by the health care unit for a given number and/or type of patients entering the health care unit 130 at a reference time, etc.

The health care management system 102 may perform operations on the data received. Processor 114 of the health care management system 102 may be configured to access, and execute computer-readable program instructions stored in the memory 116 to perform the operations described herein. For instance, the processor 114 may be configured to conduct data analysis by data analysis module 118 in memory 116 on select external conditions data and/or historical data.

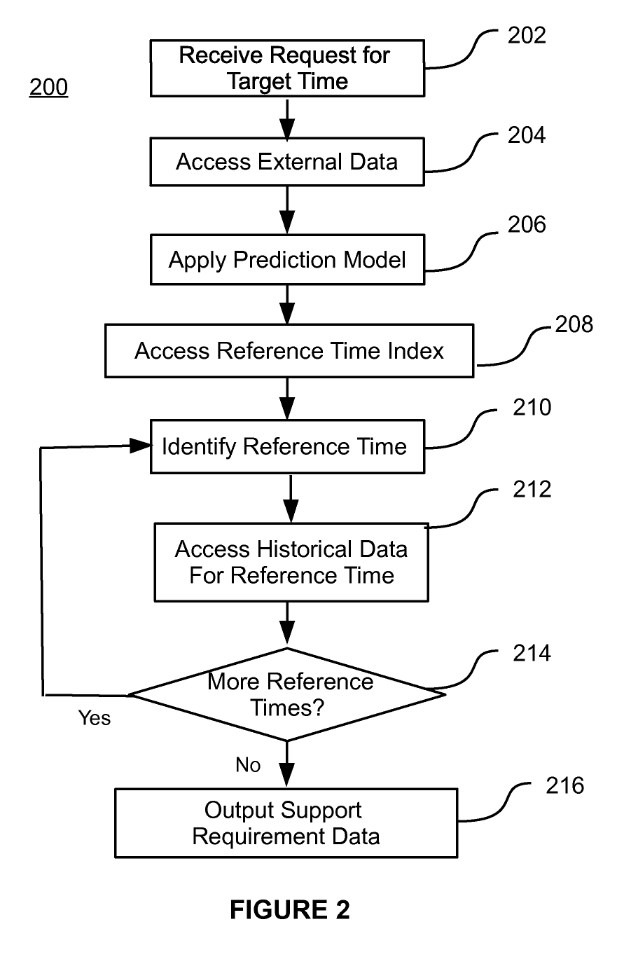

In some implementations, data analysis module 118 may apply a prediction model to the data. The prediction model may be used to generate a prediction from a known outcome. The prediction model may generate forecasts based on certain historical data and external conditions data that relate to the target time by using various processes, as described in examples in FIGS. 2 to 6 below. In some implementations, the prediction model may be built and/or modified by model component 120, such as a computer program or instructions to build and update a prediction model. The results generated by data analysis module 118, such as a support requirement, may be stored in an index in data store 124.

The processor 114 of the health care management unit 102 may be configured to carry out various additional functions to manage and/or control operations of the health care unit 130 through command module 122. For example, the processor 114 may be configured to provide instruction signals, e.g. commands, to the health care unit 130 that cause the health care unit 130 to perform one or more operations to manage health care support.

Functions of the data analysis module 118, model component 120 and command module 122 are described in further detail below with reference to the figures below.

Certain information, such as support requirements, commands to automatically perform steps by command module 122, as well as other communications may be provided by the health care management system 102 to the health care unit 130 through network 126.

In some implementations, the network 126 may include one or more computing systems and network infrastructure configured to facilitate data transfer between the health care management system 102 and health care unit 130. The network 126 may be or may include one or more Wide-Area Networks (WANs) and/or Local-Area Networks (LANs), which may be wired and/or wireless. In some examples, the network 126 may include one or more cellular networks and/or the Internet, among other networks. The network 126 may operate according to one or more communication protocols, such as LTE, CDMA, WiMax, WiFi, Bluetooth, HTTP, TCP, and the like. Although the network 126 is shown as a single network, it should be understood that the network 126 may include multiple, distinct networks that are themselves communicatively linked. The network 126 could take other forms as well.

A projected support requirement may enable a support manager 132 of the health care unit 130 to prepare and to provide an appropriate kind and amount of health care support. In some implementations, support requirements may include information useful in various types of staffing of personnel to assist in health care services, for example, nurses, physicians, specialists, administrative staff, etc. The staff members may be employees, contractors, locum tenens, volunteers, the like, and combinations thereof, associated with the health care unit. Support requirements may also include information helpful in supplemental types of support that may aid staff in caring for patients, such as health care equipment, supplies, medications, rooms, beds, space, etc.

In some example scenarios, implementations of the health care management system 102 may assist personnel in a health care unit 130 who schedule staffing of individuals who provide health care services. The health care management system 102 may reduce complexity and errors that may be associated with staff scheduling.

To account for variability in patient demands, a health care unit 130 may assign staff members to on-call or floating statuses. On-call statuses assist a health care unit 130 to ensure that unexpected patient needs may be met. A staff scheduler that utilizes a support requirement projected by the health care management system 102 and made available to a health care unit 130 can schedule such that on-call staff may be kept to a minimum, optimized, or avoided altogether. This may enable health care unit 130 to provide health care while reducing staffing costs. Further, staff may enjoy fewer disruptions to their personal lives that may be caused by frequently being on-call.

Another benefit that may be provided by the health care management system 102 in some instances, is enabling hospital staff to prepare for a rapid increase in the projected number of patients arriving at an emergency room. For example, in the case that hospital staff, through use of the health care management system 102, is informed of a potential surge in the number of patients arriving in the near future, steps may be taken to prepare for the surge; such as freeing hospital beds, stocking inventories, and alerting hospital support services. By being better prepared for unusual changes in patient load, the health care management system 102 may allow for more effective management of hospital resources, potentially leading to improved quality of the health care services and reduced cost by decreasing resource waste.

In some implementations, the scheduler 134 of the support manager 132 may utilize one or more projected support requirements as factors in deciding on scheduling of staff. The information may be useful in determining number of individual staff members to schedule, decide upon the specialties of individual staff to assign to a shift, select individual staff members for a shift, identify number of staff on call, reallocate staff already on shift to different departments, choose staff suitable particular shifts, etc. In some implementations, the support manager 132 may reference a staff roster and choose individual staff members from the roster to schedule according to the projected support requirement.

A health care provider shift is a period of time in which an individual staff member is available to provide health care services. Shifts may be any length of time, such as one to eight hours long or extended shifts over eight hours, such as twelve, sixteen or twenty-four hours. At times, a work shift may include time actively at work and time available/blocked to work as an on-call status. For example, a twelve hour shift may start at 7 a.m. and end at 7 p.m. In some cases the provider is scheduled on-call for the shift but may only have to work during the shift when required (e.g., surgeon called in to remove an appendix that is about to burst). A health care provider's shift may be regularly scheduled on certain days or may include flexible hours that may change, on a periodic basis, e.g. daily, weekly, monthly, etc.

In some implementations, the scheduler 134 may utilize one or more suitability criteria, such as one or more individual attributes of staff members, for example stored in a matrix, to determine an identifier for an individual staff member who meets the support requirement. Individual attributes may include education, training, professional certification, and years of experience, familiarity with particular patients, expertise in a given medical procedure, number of times particular medical operations have been performed by the individual, patient rating, popularity, publications, proximity of the individual staff member's location to the health care unit 130, the recency of the individual's latest shifts, etc.

The individual identifier may distinguish an individual by name, staff number, driver's license number, social security number, or other identification. In some implementations, the suitability criterion may be determined by weighing, averaging, totaling and/or otherwise considering individual attributes. In some implementations, the suitability criterion may include individual staff members' availability. For example, vacation time, sick time, resident rotations, teaching schedules, all may need to be factored into the scheduling.

In some implementations, the health care management system 102 may determine the schedules for staff according to the support requirement for the target time. The command module 122 may send a command that includes the schedule and instructions for automatically scheduling one or more staff members to the scheduler 134 of the health care unit 130. The determination of a staff schedule by the heath care management system 102 may utilize the one or more suitability criteria, for example stored in a matrix, to determine an identifier for an individual staff member who meets the support requirement as described above with regard to the scheduler 134. In response to receiving scheduling command, the scheduler 134 of the health care unit 130 may automatically, without human intervention, assign one or more schedule staff members for the target time at the health care unit, which may include posting the schedule, sending an alert to staff, or otherwise distributing the schedule information.

An alert function 136 of the support manager 132 may send messages, page notices, telephone calls, signals, and other notifications to one or more personnel 142 who may be needed to prepare for the projected support. In some implementations, a staff member is called with a reminder of a shift, new assignment, or information of a change in shift according to the support requirement. In some implementations, such alerts may be transmitted across a wired or wireless network 126. In some cases, the alert function 136 may be automatically triggered by a command sent from the command module 122 of health care management system 102.

According to various implementations, the support manager 132 may include a reservations function 138 to reserve resources to handle upcoming needs according to the support requirement. For example, reservations 138 may request a certain number of rooms or beds be held in anticipation of an increase in a support requirement. In some examples, the reservations 138 may reallocate equipment and other resources according to the support requirement. An ordering function 140 of the support manager 132 may place orders, such as purchase orders to ensure a stock of supplies, medications, etc. to accommodate the projected support requirement. In some cases, the reservations function 138 may be automatically triggered by a command sent from the command module 122 of health care management system 102.

It should be understood that the network environment 100 is one example in which embodiments described herein may be implemented. Numerous other arrangements are possible and contemplated herein. For instance, other network environments 100 may include additional components not pictured and/or more or less of the pictured components. In some implementations, components of the health care management system 102 may be combined with the health care unit 130 such that the health care unit acquires external conditions data and performs the projection of support requirements, for example, in the processes described below for FIGS. 2 to 6.

FIG. 2 illustrates an example of projection processes 200 for determining a support requirement that may be used in accordance with various implementations. In the various implementations described herein, the processor 114 of health care management system 102 may perform the steps described, such as through one or more of the model component 120, data analysis module 118 and command module 122 in memory 116.

In block 202, a request is received to provide data indicating a support requirement for a target time. The request may further specify a location of a health care unit, or such as location may be determined by a map look up, GPS device, etc. The request may be received from various inputs directly into the computer executing the method or transmitted from another computer. For example, the request may be received from a user for the health care unit 130. The request may also be a command that is automatically generated from another computer, such as a computer system at the health care unit 130. In some implementations, an initial command may be sent from a computer at the health care unit 130 to automatically perform the process shown in FIG. 2 at predefined times. For example, the health care management system 102 may be requested to automatically perform the process without further human intervention on a weekly basis, or to repeat the process at gradually more frequent times as the target time approaches, e.g. 1 year prior to target time, 6 months, 1 month, 2 weeks, 1 week, one day, 4 hours, one hour prior to the target time. In some embodiments, the request may be for a daily support requirement for a future target date that automatically changes by one day in the future.

The health care unit 130 may request to receive a support requirement at one or more particular times to provide a sufficient planning period before the health care is required according to the support requirements. The receiving time may be at any point prior to the target time of the support requirements, such as a day, a year, six months, one month, two weeks, one week, following day, four hours, one hour, etc. before the target time.

The target time may be various periods of time, such as a time of day, e.g. morning, afternoon, evening, night. In some implementations, the target time may include a time range, e.g. 9:00 am PST to 5:00 pm PST. In some implementations, such a target time may coincide with a staff shift, or the target time may be an exact time, e.g., 9:00 am PST.

In some implementations, a request for a support requirement may be a compound request that combines a number of inquiries. For example, the request may be for specific health characteristics, such as presentation of symptoms, in addition to patient count. Similarly, the request may ask for data indicating a support requirement in the form of staffing requirements, such as an overall number of staff required for a target time as well as a breakdown of the number of staff for specialty areas of health care, such as administrative staff, surgeons, nurses, etc. In some implantations, the staffing requirements may include an identifier for a particular staff member to work a specific shift.

In another example, the request may be for data indicating a support requirement that include amount, number and/or types of equipment, supplies, medications, beds, space, etc. In some implementations, the request to the health care management system 102 may be coupled with one or more requests for action commands, such as automatic staff scheduling, ordering, reservations and distribution of alerts by the health care unit 130.

There may be various types of requesters that request support requirements, such as the health care unit 130, as well as requesters, that monitor or assess health care providers, (e.g. organizations or departments that oversee) who desire information related to the support requirements. Some requesters for related information may include a notifier that seeks the availability of health care providers in a territory that may include the health care unit 130 or particular resources, such as a specialty area of the area serviced by the health care unit 130.

The notifier may provide data indicating a support requirement in the form of availability information to a recipient, such as a patient or other consumer, caregiver, emergency medical technician (EMT), emergency medical dispatcher, other health care units, and others who may benefit from understanding availability of a health care unit 130 at a target time. The availability information may be interpreted from the basic data, for example, by calculating the projected basic results of the support requirement and factoring it with support that a health care unit 130 may have available at the target time to provide care to patients. For example, if a health care unit 130 is projected to be at capacity to provide care for a projected support requirement, the availability information may reflect limited availability to provide additional care to further patients. In some implementations, the availability information may include projected wait times for patients requiring care at the health care unit 130.

In some implementations, an EMT or emergency medical dispatcher may want to be aware of a health care unit that has capacity to receive certain patients, e.g. urgent cases, patients with specialty care needs, etc. The EMT or dispatcher may use the availability information to determine which of one or more health care units 130 may have readiness to accommodate its needs. In some implementations, another health care unit may use the availability information to determine whether to transfer a patient to the health care unit 130 that has availability to accommodate the patient. Such information may allow for efficient patient flow at various health care units by distributing patients. In some implementations, a patient, e.g. a future patient, or a caregiver of a patient who is seeking a health care provider may request availability information from the health care management system 102 to find a health care unit having the lowest potential wait time.

In the foregoing examples, the availability information of a health care unit 130 may include a projection of patients as well as the capacity of the health care unit 130 to serve the patient projection at the target time. The availability information may be accompanied by additional selection information useful in making a decision to go to a particular health care provider, such as prediction of turnaround time for patients being cared for by a health care unit 130, proximity of the health care unit 130 to the requester, etc. The availability information determined by the health care management system 102 may be provided directly or indirectly to a notifier or to another requester.

In block 204 of FIG. 2, external conditions data for a plurality of different external conditions projected for the location at the target time may be accessed. The external conditions data may be associated with a plurality of different external conditions, as described above with regard to FIG. 1. In some implementations, the health care management system 102 may receive external conditions data that an external source had projected for the location and target time. In still some implementations, the health care management system 102 may receive external conditions data for one or more reference times from which the data analysis module 118 may project external conditions data for the location and target time. For example, patterns in the external conditions data for reference times may be interpreted to determine the external conditions data for the target time and location.

In some implementations, as shown in block 206, a prediction model may accept the target time, which may include target time characteristics, and also accept external conditions data as inputs.

The prediction model may be created by the health care management system 102 or by a different computer. In some implementations, the prediction model may be applied from a prior process, and then later performed to run in real time and project a support requirement. In some scenarios, the prediction model need not be built at the same time as the projection process.

The prediction model may be built in whole, or in part, prior to receiving a request in block 202, or after receiving a request in block 202 and prior to accessing data in block 204. In some implementations, a portion of the prediction model may be constructed through one or more preliminary step, e.g., data processing and data organizing, prior to receiving a request for a support requirement. In these cases, additional steps are performed to build the prediction model in response to receiving the request for a support requirement. In some implementations, a prior prediction model may be modified and the modified prediction model is used. For example, the prediction model may be adapted to a request for a support requirement that may specify particular external conditions, a target time, weighting of parameters, etc. In other implementations, the prediction model is built in its entirety in response to receiving the support requirement request.

Various prediction algorithms or techniques may be used in the projection process 200 by the health care management system 102 to generate a prediction model and calculate the data indicating a support requirement at a target time and/or location given historical data for a reference time and/or external conditions data. For example, health care management system 102 may use time series methods, regression models, or Bayesian inferences, among other examples.

Regression models, such as random forest regression, support vector regression, and kernel regression, among other examples, may be used to provide predictions that are based on repeating temporal trends in historical data. Such trends may occur on daily, weekly, monthly, yearly or other intervals. These regression models may be also be informed by irregular trends such as weather, outbreaks of diseases and secular trends. The regression models, which provide a baseline prediction, can be augmented with a time series method, which is designed to capture temporal variations in recent data. Among the time series methods that can be used to augment a baseline prediction are autoregressive techniques, such as autoregressive moving average (ARMA), autoregressive integrated moving average (ARIMA), and vector autoregression (VAR), among other autoregressive techniques. Additional time series methods that can be used include moving average, weighted moving average, Kalman filtering, exponential smoothing, extrapolation, linear prediction, and recurrent neural networks, among other examples. It will be appreciated that health care management system 102 may use other known or later developed prediction models, and techniques to build such prediction models.

At times, the historical data and/or external conditions data may require formatting prior to applying the data to the prediction model. Such operations may include compression and/or decompression, encryption and/or de-encryption, analog-to-digital and/or digital-to-analog conversion, filtration, and amplification, among other operations. Moreover, the health care management system 102 may be configured to parse, sort, organize, and/or route data based on data type and/or characteristics of the data. One or more input values may be created based on the historical data and external conditions data. Where formatting of data is necessary the step may be performed at any point in the projection process 200 after accessing the data in block 204.

The prediction model, in block 208, may access a reference time index. The index may include one or more reference times, such as dates, and, in some implementations, one or more time characteristics for the reference time.

The prediction model, in block 210, may identify a reference time that is predictive of the target time. In some implementations, the model may make such a determination based, at least in part, on evidence that suggests a particular reference time may relate to and predict the target time. Previous experience, studies, or other assumptions may provide evidence of relationships. For example, a reference time may be a date one year prior to the target time. In other examples, the reference time may be close to the target time, such as one week prior to the target time. In some implementations, a common time characteristic may suggest relationship between a reference time and target time, such as a date in which a holiday occurs.

The prediction model, in block 212, may access historical data for the reference times. For example, the index may include historical data associated with reference times. In some implementations, the health care management system may request historical data for a given reference time and receive the historical data from a data source.

The decision step of block 214 establishes whether there are additional reference times that correlate with the target time in the reference time index. If there are additional reference times, the process may proceed to step 210 to identify an additional reference time. However, if it is determined that there are no additional reference times, the health care management system 102 outputs data indicating support requirements in block 216. The output data indicating a support requirement may be determined by the prediction model, based, at least in part, on the historical data and the target time.

The result may be in a presentation form of support requirement that may be directly conveyed to the health care unit 130 or other requesters of the information. In some implementations, the output result may require further configuring to create a presentation form of the support requirement. In some implementations, the result may need to be formatted into a readable form for the computer device of the health care unit 130. For example the result may be presented as data indicating a support requirement in the form of numbers, tables, graphs, text, audio, etc.

In some implementations, the output result may require additional computation to prepare the support requirement. For example, the output result may include a projected patient count for reference times. In this example, the health care management system 102 may further process the result to determine the number of staff projected to be needed to accommodate the projected patient count. Additional information may be determined from the output results, including the number of beds needed to accommodate the projected patient count, or the average time spent in the waiting room by patients, among other examples. Thus, the support requirement provided, as shown in block 216, may include one or more of patient count, staff forecast, number of beds needed, and any other quantity needed to support the projected patient count. In some implementations, the projected patient count can be divided into groups based on projected medical acuity, or severity of the medical conditions affecting the patients in a group. Consequently, the support requirement may be determined separately for the patients in each of the acuity groups. For example, the support requirement provided for the patients in the high acuity group may be more extensive than that provided for patients in the low acuity group.

In some implementations, the support requirement may be presented in time chunks for the target time. For example, the support requirement may include morning, afternoon, evening times or time periods that coincide with staff shifts. In block 216, once the support requirement is in a proper form for presentation, it may be provided to the requesters, e.g., health care unit 130.

In some implementations, the results and support requirement may be stored, e.g. for later reference, in some implementations. The results and support requirement may be inserted into an index having the support requirements previously determined for the health care unit 130 and representing other target times. Such an index may also include actual support provided by the health care unit 130 for one or more past target times for the health care unit 130. A comparison of the actual support provided with the projected support requirement may be used by the health care management system 102 to train prediction models and external conditions that enable effective projections of support requirements. The health care management system 102 may, for example, adjust prediction models, choose different external conditions, or modified external conditions according to the training.

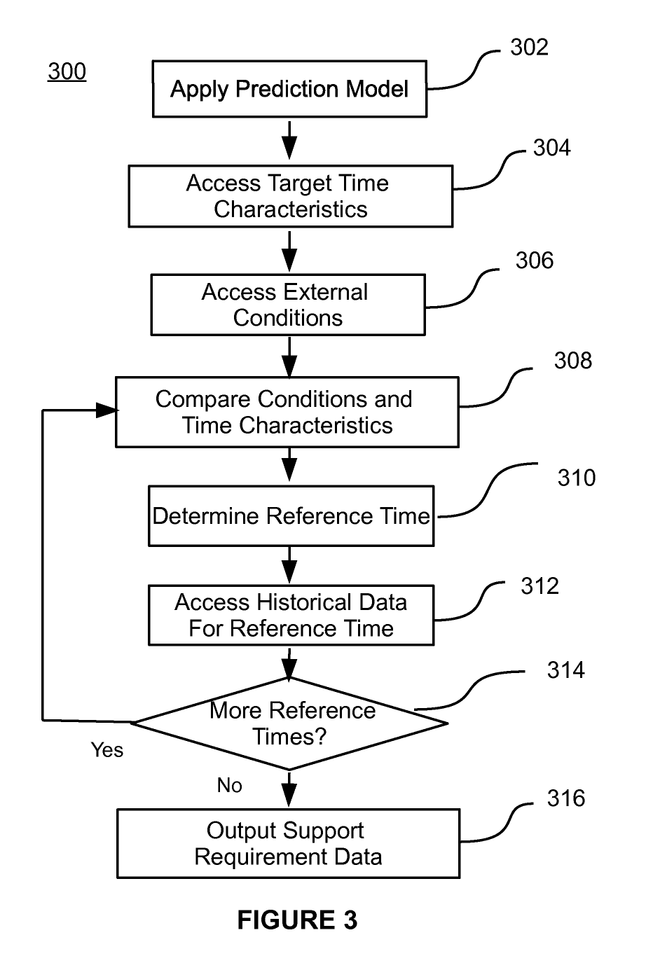

FIG. 3 is a flow diagram of an example projection process 300 by the processor 114 of health care management system 102, for determining a support requirement by using one or more target times and external conditions. In the approach shown in FIG. 3, the target time and any associated time characteristics and external conditions data projected for the target time may be treated as a single set of data attributes to identify one or more reference times and corresponding historical data for the reference times.

The projection process 300 may initiate with one or more steps described above with regards to FIG. 2. For example, a request may be received to provide a support requirement for a target time as in block 202. In block 302 of FIG. 3, a prediction model may be employed. In some implementations, the prediction model may be defined, built and/or trained in advance of receiving the request for a target time.

In block 304, the prediction model may access the target time and its characteristics, such as day of the week, time of day, holiday, etc., which may be stored in an index. In block 306, the prediction model may access external conditions data projected for the target time that may also be stored in the index. In some implementations, the projection of external conditions data may also consider the location of the requesting health care unit 130.

In block 308, a reference time index may be accessed to compare the times and external conditions data to identify a reference time. The reference time index may include historical data (e.g. patient counts), and external conditions data for one or more past reference times.

The prediction model may determine a reference time in block 310 that has similar target time characteristics (e.g. day and time of day), as well as similar external conditions. In block 312, historical data, such as a patient count, is accessed for the reference time. The historical data and the corresponding reference times may be stored in the reference time index.

Decision step of block 314 determines whether there are other reference times to compare. If the processor 114 of health care management system 102 concludes that there are additional reference times, the process proceeds back to step 308 to further compare the time characteristics and external conditions to identify an additional reference time. However, if it is determined that there are no additional reference times, the process outputs data indicating a support requirement in block 316.

In some implementations, the process determines data indicating a support requirement by combining or aggregating historical data for the reference points to project the data indicating a support requirement. For example, an average of the historical data from the reference times may be determined. In some implementations, historical data may be grouped according to one or more health characteristics, such as a level of criticality, and the average of the historical data groups may be determined based on the health characteristics. Other implementations that aggregate historical data in other ways are possible.

In some implementations, the historical data for the various reference times may have an associated weight. The weight may be based on a closeness of the match between the target time characteristics and attributes of the reference times.

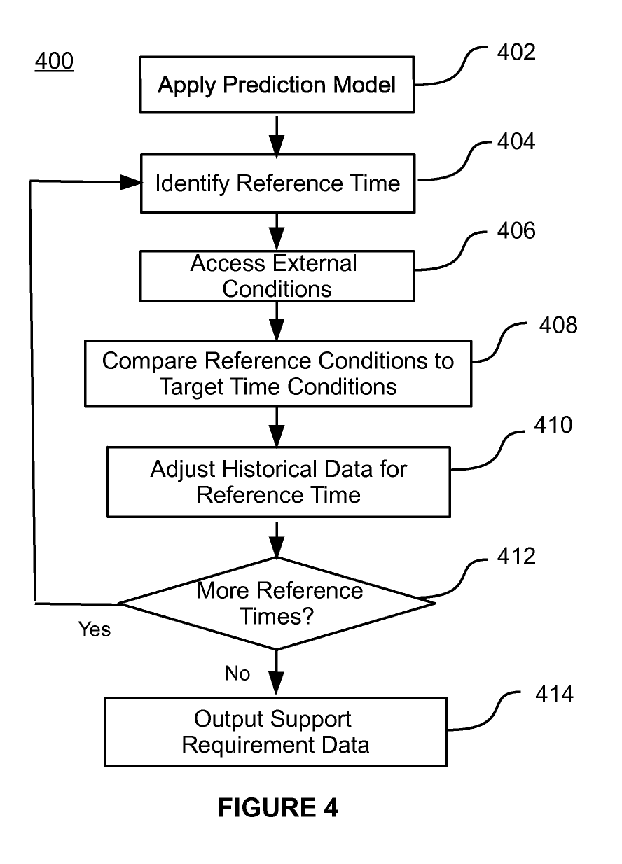

FIG. 4 is a flow diagram of an example projection process 400 by the processor 114 of health care management system 102, for determining a support requirement by using a target time and any associated time characteristics to determine one or more reference times.

The projection process 400 may initiate with one or more steps described above with regards to FIG. 2. For example, a request may be received to provide a support requirement for a target time as in block 202. In FIG. 4, block 402, a prediction model may be employed. In some implementations, the prediction model may be defined, built and/or trained in advance of receiving the request for a target time.

In block 404, a reference time may be identified that may correlate with the target time. The projection process 400 may access external conditions data for the reference time, in block 406. In block 408, the prediction model may compare the external conditions data for the reference time to projected external conditions data for the target time, and in some implementations, also the location. In some implementations, one or both target time and the location of the health care unit may be used to project external conditions data. For example, external conditions data on a future date in a particular city, county, region, street, district, etc. may be projected.

Based on the comparison of external conditions, the historical data associated with the reference time may be adjusted, as shown in block 410. For example, if the weather for the reference time was sunny and the weather for the target time is projected as rainy, the historical data for the reference time may be adjusted by a related amount. In some implementations, the reference time and its historical data may be discarded and not used in determining support requirements for the target time, for example, when the comparison of the external conditions data does not meet a threshold comparison value.

Decision step of block 412 determines whether there are other reference times to compare. If the processor 114 of health care management system 102 concludes that there are additional reference times, the process proceeds back to step 404 to further compare the time characteristics to identify an additional reference time. However, if it is determined that there are no additional reference times, the process outputs data indicating support requirements in block 414. In some implementations, the data indicating support requirements are generated by combining or aggregating the adjusted historical data for the reference times.

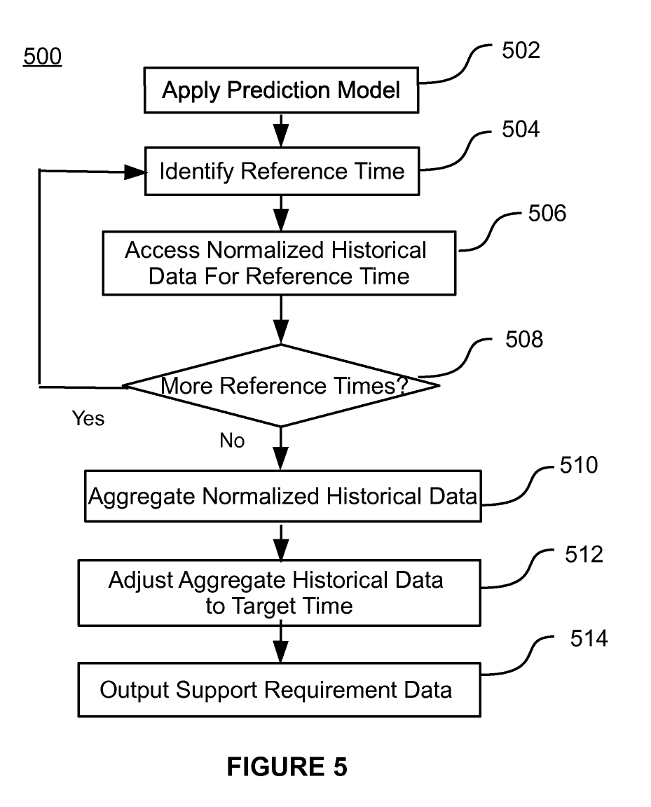

FIG. 5 is a flow diagram of an example projection process 500, by the processor 114 of health care management system 102, for determining a support requirement by using a target time and any associated time characteristics to determine one or more reference times.

The projection process 500 may initiate with one or more steps described above with regards to FIG. 2. For example, a request may be received to provide a support requirement for a target time as in block 202. In FIG. 4, block 502, a prediction model may be employed. In some implementations, the prediction model may be defined, built and/or trained in advance of receiving the request for a target time.

In block 504, a reference time may be identified that may correlate with the target time, as previously described with regard to FIG. 4. In block 506, previously normalized historical data for the reference time may be accessed. For example, during a pre-processing phase, one or more baseline external conditions and/or time characteristics may be used to normalize historical data for various reference times to the baseline factors. The normalized historical data may be stored in the reference index prior to receiving a request for a support requirement.

Decision step of block 508 determines whether there are other reference times. If the processor 114 of health care management system 102 concludes that there are additional reference times, the process proceeds back to step 504 to further compare the time characteristics to identify an additional reference time. However, if it is determined that there are no additional reference times, the projection process 500 may proceed to block 510 to combine or aggregate normalized historical data for the reference times. In block 512, the aggregated historical data may be adjusted to account for any variances between the baseline external condition and projected external condition for the target time, and in some implementations, the location. For example, comparison of the projected external condition for target time and external condition for the reference time could establish the difference in the predictive variables. The effect of these differences would be input into the predictive model to calculate the change in the output expected from these differences. In block 514, data indicating support requirements may be output.

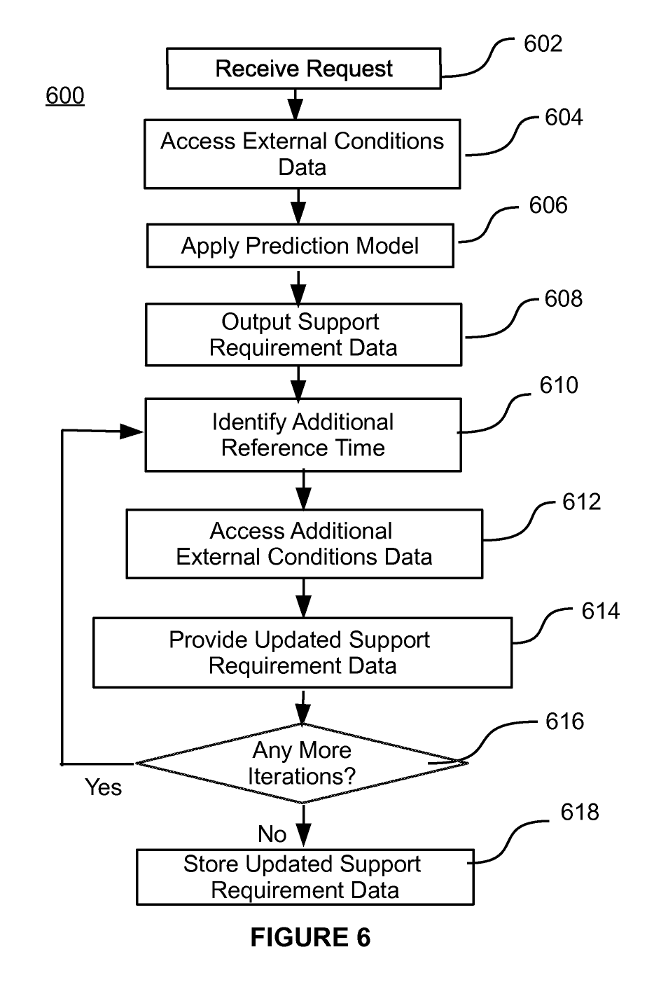

FIG. 6 shows by way of a flow diagram of an example of updating projections of a support requirement. In some implementations, the health care management system 102 may run multiple iterations of the iterative update projection process 600, which may be performed by the processor 114 of the health care management system 102. In block 602 a request may be received, such as from the health care unit 130, comparable to the request described with regard to block 202 in FIG. 2. The request in block 602 may include a request for support requirement at various intervals prior to the target time.

The frequency of iterations may depend on various factors, for example, how often historical and/or external conditions data changes, statistical impact of external conditions data change, whether changes in external conditions data also change the result, nearness to the target time, etc. The health care unit 130, for example, may use an early projection of a support requirement, for example, 6 months to a year prior to the target date, to conduct planning to accommodate the support requirement. By the iterative projection process 600, health care unit 130 may receive updated data indicating support requirements the current time (e.g. date) gets nearer to the target time.

In block 604, external conditions data for one or more reference times may be accessed, as described above with regards to block 204 in FIG. 2. In block 606, a prediction model may be applied in steps similar or the same as blocks 206 to 214 in FIG. 2. In block 608, data indicating a support requirement may be output, such as the step described in block 216 of FIG. 2.

The iterative update projection process 600 may conduct one or more iterations to produce one or more updated data indicating a support requirement using various additional reference times prior to the target time.

In block 610, one or more additional prior reference times may be identified. In some implementations, the additional reference times may include one or more times that are progressively closer to the target time than a previous iteration and the additional reference time is prior to the target time. In block 612 additional external conditions data for one or more additional reference times may be accessed, e.g. external conditions data for a first update iteration

In block 614, an updated support requirement may be determined by the prediction model. The data indicating an updated support requirement may show an increase, decrease or no change from the original support requirement. In some implementations, the updated support requirement reflects more current historical and/or external conditions data. In block 614, the updated support requirement may be provided to computer devices of interested parties outside of the health care management system 102, such as the requesting health care unit 130.

The iterative projection process 600 may include a determination of whether further iterations should be performed, as shown in decision block 616. In some implementations, the health care management system 102 may be preconfigured to automatically perform subsequent iterations as designated points of time or intervals. The request may also include a request for a support requirement at particular times. If a subsequent iteration is needed, the process returns to block 610. When no more iterations are needed, in some implementations, the process may proceed to block 618 and store the updated support requirement.

In some implementations, the health care management system 102 may be configured to monitor the support requirements for the health care unit 130 and determine whether a support requirement meets a threshold. The threshold may be predetermined and stored in an index or dynamically determined by the health care management system 102. Various actions are possible in the event that a support requirement meets the threshold. For example, the health care management system 102 may transmit a warning or alert to the health care unit 130. The health care management system 102 may also generate a list of one or more recommended actions that may help the health care unit 130 adjust support to accommodate the rise in a support requirement. Other actions are also possible.

In some implementations, the processes shown in FIGS. 2 to 6 may be applicable to other service fields related or unrelated to health care areas, in which an entity may benefit from predictions of potentially fluctuating future service requirements in order to plan resources in accommodate the projected service requirements, such as schedules for staffing. Non-limiting examples of such service industries that may receive projected service requirements include restaurants, bars, transportation, e.g. airlines, bus transit, rail, etc., tourism, entertainment, and other service fields.

For example, referring to FIG. 2, a service management system may be employed and with use of its processor, it may make forecasts of services needed by future customers. The service management system may receive a request for projected requirements for a future target time, as shown in block 202. The service management system may access external conditions data of a service entity associated with a plurality of different external conditions as in block 204. The process may apply a prediction model as in block 206. The prediction model may be built and/or modified as needed. In some implementations input data may be formatted. As shown in block 210, a reference time may be identified and historical data for the reference time may be accessed as in block 212. If there are more reference times, the process may repeat to identify the reference time and access historical data. Data indicating a support requirement may be output, as in block 216. In further implementations in other service fields, the process may be repeated for one or more iterations, as described in FIG. 6.

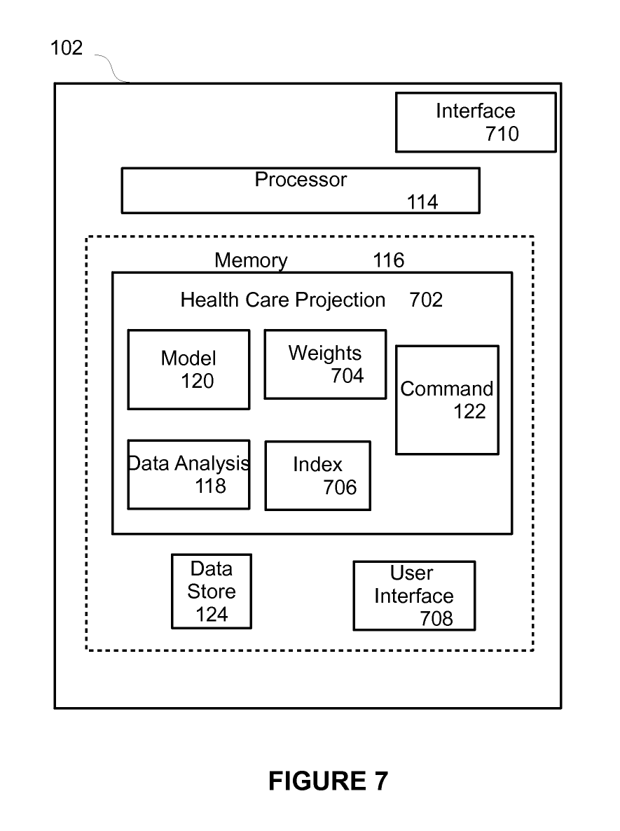

In FIG. 7, an example of the health care management system 102 and at least some of its optional components are shown. The health care management system 102 may include one or more processors 114 and memory 116. The processor 114 may process instruction for execution within the health care management system 102 including instructions stored in memory 116 and/or in the data store 124. In some implementations, multiple processors 114 may be used.

One or more interfaces 710 may generally function to receive data from various network components of the network environment 100, such as from a number of different external conditions data sources 104, receive data and requests from health care unit 130 and to output data to health care unit 130, output requests to data sources 104, etc. Specifically, the interface 710 may be configured to receive and transmit analog signals, data streams, and/or network packets, among other examples. As such, the interface 710 may include one or more wired network interfaces, such as a port or the like, and/or wireless network interfaces. In some examples, the interface 710 may be or include components configured according to a given dataflow technology.

The processor 114 and memory 116 may be implemented as a chipset of chips that include separate and multiple analog digital processors. The processor 114 may also be implemented using various architectures. For example, the processor 114 may be a CISC (Complex Instruction Set Computer) processor, RISC (Reduced Instruction Set Computer) processor or MISC (Minimal Instruction Set Computer) processor.

Processor 114 includes any suitable hardware and/or software system, mechanism or component that processes data, signals or other information. The processor 114 may include a system with a general-purpose central processing unit, multiple processing units, dedicated circuitry for achieving functionality, or other systems. Processing need not be limited to a geographic location, or have temporal limitations. For example, the processor 114 may perform its functions in “real-time,” “offline,” in a “batch mode,” etc. Portions of processing may be performed at different times and at different locations, by different (or the same) processing systems.

The memory 116 stores information within the health care management system 102. The memory 116 may be any suitable data storage, memory and/or non-transitory computer-readable storage media, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided for example in the form of software as a service (SaaS) delivered from a server (e.g., a distributed system and/or a cloud computing system).

The one or more processors 114 may implement various modules for forecasting health care needs in a health care projection component 702 in the memory 116. The data analysis module 118 performs any calculations required to deliver the health care information based on historical and/or external conditions data to another computer device, e.g., health care unit 130, notifier, patient, caregiver, dispatch unit, EMT, organization overseeing, monitoring or assessing health care providers, etc. In some implementations, a prediction model is used by the data analysis module 118. The prediction model may be stored, modified and built by model component 120.

In some implementations, a weight module 704 may assign weights to external conditions data, external conditions data parameters, or historical data to denote grades of significance. Weights may be based on potential impact on the support requirement. For example, external conditions that have potential to show a dramatic, such as a sudden or large, increase or decrease in a support requirement may be weighted more than external conditions that typically reflect less or gradual changes. In some circumstances, external conditions that indicate changes in a specialty area may be weighted more. The health care unit 130 may also request preferences for certain external conditions. Weights may also be attributed to reliability of the external condition to predict a support requirement.

In some implementations, determining weights by weight module 704 may include ascertaining a regression coefficient associated with one or more external condition and/or historical data. The health care management system 102 may modify the weights assigned to external conditions and historical data as the health care management system 102 learns from prior results and other sources. Such learning may make use of an index stored, constructed and/or modified by index module 706.

Memory 116 may additionally include one or more user interface 708 that may be configured to facilitate user interaction with the health care management system 102. In some implementations, the user interface may enable a user to adjust functions of the health care management system 102 to customize a support requirement for a requester.

Examples of user interfaces 708 include touch-sensitive interfaces, mechanical interfaces (e.g., levers, buttons, wheels, dials, keyboards, etc.) and other input interfaces (e.g., microphones), among other examples. In some cases, the user interface 708 may include or provide connectivity to output components, such as display screens, speakers, headphone jacks, and the like.

Data store 124 may store applications and other data. At least a portion of the information may also be stored on a disk drive or other computer readable storage device (not shown) within the health care management system 102. Such storage device include a floppy disk device, a hard disk device, an optical disk device, or a tape device, a flash memory or other similar solid state memory device, or an array of devices.

A computer program, also referred to as programs, software, software applications or code, may also contain instructions that, when executed, perform one or more methods, such as those described herein. The computer program may be tangibly embodied in an information carrier such as computer or machine readable medium, for example, the memory 116, or a storage device or memory on processor 114. A machine readable medium is any computer program product, apparatus or device used to provide machine instructions or data to a programmable processor.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

The health care management system 102 may be implemented in a variety of forms. In some implementations, the computer device of health care management system 102 may be substituted with one or more networked servers, such as servers in a cloud computing network. In some implementations, it may be implemented in a personal computer such as a laptop computer. In some implementations, the health care management system 102 may be an integral component of the health care unit 130. In still some implementations, the health care management system 102 may communicate with a requester, such as health care unit 130, through interface 710.

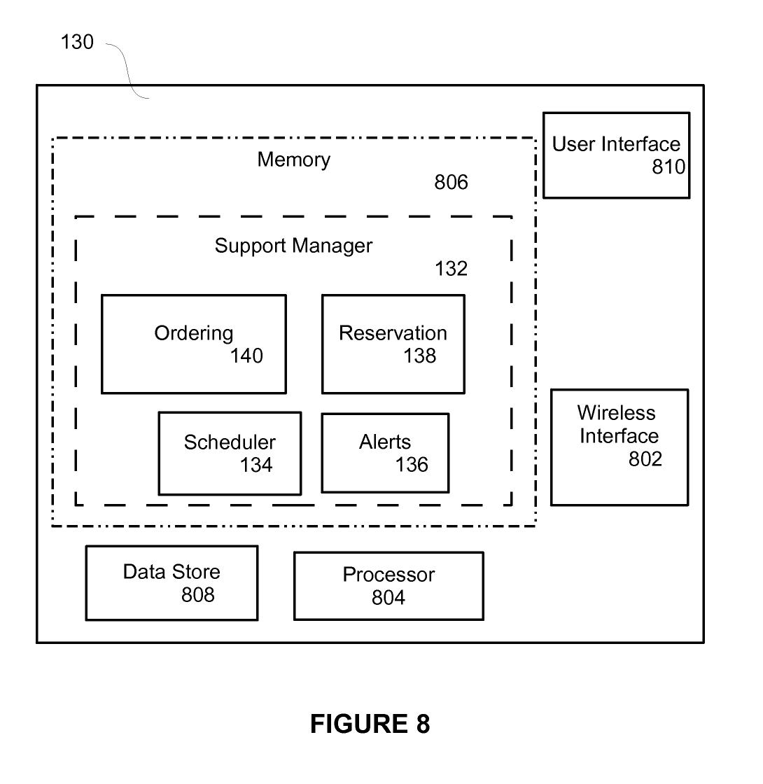

In FIG. 8, a schematic diagram illustrating selected example components of a computing device of a health care unit 130 that implements planning for the provision of health care based on a projection of a support requirement. The health care unit 130 and at least some of its components are shown, according to some implementations. Health care unit 130 may communicate through an interface, such as a wireless interface 802, and across a network 126 with the health care management system 102 at its interface 802. For example, requests and historical data may be transferred from the interface 802. Commands and support requirements, for example, may be transferred to the interface 802.

In some implementations, the computer device of the health care unit 130 may be substituted with one or more networked servers, such as servers in a cloud computing network. In some implementations, it may be implemented in a personal computer such as a laptop computer, mobile device (e.g., smartphone), personal digital assistant, tablet, a wrist watch and other wearable computers, head mounted display, among devices capable of inputting requests, and receiving and imparting results.

The processor 804 of the health care unit 130 may process instruction for execution within the health care unit 130 including instructions stored in memory 806 or on the data store 808. The processor 114 may coordinate components of the health care unit 130, e.g., applications, wireless or wired communication through interfaces 802, etc. In some implementations, multiple processors and buses may be used.

The support manager 132 of the health care unit 130 may include modules, including for example, scheduler 134, ordering 140, reservation 138 and alerts 136, to prepare the health care unit 130 to provide appropriate kind and/or amount of health care support.

A user interface 810 may also be provided to enable a user to make particular requests, receive a support requirement, receive alerts or notifications, view a support requirement, etc. The user interface may receive various inputs including, without limitation, touchscreen, switch input with an on-screen or external keyboard, head mouse, voice recognition, gesture recognition, facial recognition, movement tracker, eye movement tracker, smart buttons, trackball, track pen, pen tablet, pen, stylus, and hand mouse. The input may include a user applying touch, voice, click, tap, type, gestures, movement (e.g. moving an eye, arm, body), and other actions. Furthermore, the user interface may provide various outputs including visual display, audio, voice prompts, etc.

A number of implementations have been described. Features described with conditional language may describe implementations that are optional. The functional blocks, methods, devices, and systems described in the present disclosure may be integrated or divided into different combinations of systems, devices, and functional blocks as would be known to those skilled in the art. Although the description has been described with respect to particular implementations thereof, these particular implementations are merely illustrative, and not restrictive. Concepts illustrated in the examples may be applied to other examples and implementations. Thus, various modifications may be made without departing from the spirit and scope of this disclosure and other implementations are within the scope of the following claims.

1. A method implemented by a computing device, the method comprising:
receiving a request to project a support requirement at a health care unit in a location at a target time;
accessing external conditions data for a plurality of different external conditions projected for the location at the target time;
providing the target time and the external conditions data into a prediction model;
identifying, by the prediction model, one or more reference times prior to the target time that are predictive of the target time;
accessing, by the prediction model, historical data for a support requirement for each of the one or more reference times;
outputting, by the prediction model, data indicating the support requirement at the health care unit for the target time based, at least in part, on the historical data and the external conditions data for the target time; and
providing the data indicating the support requirement to another computing device for use in preparing patient support at the health care unit to meet the data indicating the support requirement.

2. The method of claim 1, wherein the another computing device comprises a staff scheduler for the health care unit and the method further comprises providing a command to the staff scheduler to automatically schedule one or more staff members for the target time at the health care unit based, at least in part, on the data indicating a support requirement.

3. The method of claim 2, further comprising providing a second command to the staff scheduler to automatically provide an alert to the one or more of the staff members scheduled for the target time.

4. The method of claim 2, further comprising determining an identifier for the one or more staff members that meet a suitability criterion, wherein the suitability criterion is based, at least in part, on an individual attribute of the one or more staff members and wherein providing the command to the staff scheduler is further based, at least in part, on the identifier for the one or more staff members.

5. The method of claim 1, wherein the historical data comprises one or more health characteristics indicating a support requirement.

6. The method of claim 1, wherein external conditions data comprises data for at least one of weather, pollen count, traffic, air quality, crime activity or disease trend.

7. The method of claim 1, wherein outputting the data is further based, at least in part, on one or more weights associated with the external conditions data.

8. The method of claim 1, further comprising accessing time characteristics for the location at the target time and wherein identifying the one or more reference times comprises accessing external conditions data and time characteristics for potential reference times and comparing the potential reference time external conditions data and time characteristics to the external conditions data and time characteristics for the location at the target time.

9. The method of claim 1, further comprising:
accessing external conditions data for the one or more reference times,
comparing the external conditions data at the one or more reference times to the external conditions projected for the location at the target time, and
adjusting the historical data for each of the one or more reference times based, at least in part, on the comparison, and
wherein outputting the data indicating the support requirement for the target time is further based, at least in part, on the adjusted historical data for each of the one or more reference times.

10. The method of claim 1, wherein identifying the one or more reference times comprises accessing an index of normalized historical data reflecting a normalized support requirement for each of the one or more reference times based, at least in part, on external conditions at the one or more reference times, and
wherein outputting the data indicating a support requirement for the target time is further based, at least in part, on the normalized historical data reflecting a support requirement for each of the one or more reference times.

11. The method of claim 1, wherein receiving the request to provide the support requirement comprises receiving the request from the another computing device.

12. A computing system comprising:
one or more processors; and
a non-transitory computer-readable medium; and
program instructions stored on the non-transitory computer-readable medium that are executable by the one or more processors to cause the computing system to:
receive a request to project a support requirement at a health care unit in a location at a target time;
access external conditions data for a plurality of different external conditions projected for the location at the target time;
provide the target time and the external conditions data into a prediction model;
identify, by the prediction model, one or more reference times prior to the target time that are predictive of the target time;
access, by the prediction model, historical data for each of the identified reference times;
output, by the prediction model, data indicating the support requirement for the target time based, at least in part, on the historical data and the external conditions data for the target time; and
provide the data indicating the support requirement to a computing device for use in preparing patient support at the health care unit to meet the data indicating a support requirement.

13. The computing system of claim 12, wherein the computing device comprises a staff scheduler for the health care unit and wherein the instructions are further executable by the one or more processors to cause the computing system to provide a command to the staff scheduler to automatically schedule one or more staff members for the target time at the health care unit based, at least in part, on the data indicating the support requirement.

14. The computing system of claim 13, wherein the instructions are further executable by the one or more processors to cause the computing system to:
provide a second command to the staff scheduler to automatically provide an alert to the one or more staff members scheduled for the target time.

15. The computing system of claim 13, wherein the instructions are further executable by the one or more processors to cause the computing system to:
determine an identifier for the one or more staff members that meet a suitability criterion, wherein the suitability criterion is based, at least in part, on an individual attribute of the one or more staff members and provide the command to the staff scheduler to automatically schedule the one or more staff members is further based, at least in part, on the identifier for the one or more staff members.

16. The computing system of claim 12, wherein the instructions are further executable by the one or more processors to cause the computing system to:
determine data indicating a support requirement for the one or more reference times,
compare external conditions data at the one or more reference times to the external conditions projected for the location at the target time, and
adjust the data indicating a support requirement for each of the one or more reference times based, at least in part, on the comparison, and
wherein output of the data indicating the support requirement for the target time is further based, at least in part, on the adjusted data indicating a support requirement at the one or more reference times.

17. The computing system of claim 12, wherein the instructions are further executable by the one or more processors to cause the computing system to:
determine data indicating a support requirement for the one or more reference times, and
normalize the data indicating the support requirement based, at least in part, on external conditions at the one or more reference times, and
wherein output of the data indicating the support requirement for the target time is further based, at least in part, on the normalized data indicating a support requirement at the one or more reference times.

18. The computing system of claim 12, wherein the historical data comprises one or more health characteristics indicating a support requirement.

19. A non-transitory computer-readable medium having instructions stored thereon that are executable to cause a computing system to:
receive a request to project a support requirement at a health care unit in a location at a target time;
access external conditions data for a plurality of different external conditions projected for the location at the target time;
provide the target time and the external conditions data into a prediction model;
identify, by the prediction model, one or more reference times prior to the target time that are predictive of the target time;
access, by the prediction model, historical data for a support requirement for each of the one or more reference times;
output, by the prediction model, data indicating the support requirement at the health care unit for the target time based, at least in part, on the historical data and the external conditions data for the target time; and
provide the data indicating the support requirement to another computing device for use in preparing patient support at the health care unit to meet the data indicating the support requirement.

20. The non-transitory computer-readable medium of claim 19, wherein the support requirement comprises a staffing requirement.
